(19) United States
(12) Patent Application Publication
(10) Pub. No.: US 2010/0164675 A1
(43) Pub. Date: Jul. 1, 2010

(54) METHOD FOR PRODUCING A CYLINDRICAL RADIO-FREQUENCY SHIELD OF A CYLINDRICAL GRADIENT COIL FOR A MAGNETIC RESONANCE SYSTEM

(76) Inventors: Michael Eberler, Postbauer-Heng (DE); Thomas Kolbeck, Kalchreuth (DE); Johann Schuster, Oberasbach (DE)

Correspondence Address: SCHIFF HARDIN, LLP;PATENT DEPARTMENT, 233 S. Wacker Drive-Suite 6600, CHICAGO, IL, 60606-6473, US

(21) Appl. No.: 12/377,067

(22) PCT Filed: Aug. 28, 2007
(86) PCT No.: PCT/EP07/58926

§ 371 Date: Feb. 10, 2009

(30) Foreign Application Priority Data
Aug. 29, 2006 (DE) 10 2006 040 418.1

(51) Int. Cl. H01F 27/36; B23K 13/01; B23K 1/002

(52) U.S. Cl. 336/84 R; 219/607; 219/616; 336/225; 336/225

(57) ABSTRACT

In a method for manufacturing a cylindrical high-frequency shield of a cylindrical gradient coil for a magnetic resonance system, a number of planar shield elements are placed adjacent to one another on a cylindrical support, together with a solder band or solder strip on the support. The segments or elements are inductively soldered together by an inductive soldering device that moves along a longitudinal axis of the cylindrical support.

### BACKGROUND OF THE INVENTION

1. Field of the Invention

The present invention concerns a method to produce a cylindrical radio-frequency shield of a cylindrical gradient coil, wherein the radio-frequency shield is composed of multiple flat shield segments arranged next to one another that are soldered with one another into a cylinder shape by a soldering device using a solder band.

2. Description of the Prior Art

As is generally known, in a magnetic resonance system a gradient coil serves to generate gradient fields serving for spatial resolution. In a finished magnetic resonance system, the radio-frequency system (which is the transmission and reception system) is integrated inside the gradient coil. In order to protect the gradient coil from possible interfering influences of the radio-frequency system, the gradient coil is lined with a radio-frequency shield on its inner surface. This radio-frequency shield typically is composed of an insulating carrier that is laminated on both sides with a copper coating. A casting mandrel, which is an oblong, cylindrical carrier, is used to produce such a radio-frequency shield or, respectively, the gradient coil itself. Multiple (typically two or four) flat shield segments that in their entirety form the radio-frequency shield after production are initially placed on this carrier. The shield segments are to be connected with their inner copper layers resting directly on the casting mandrel and in order to form a closed cylindrical shape so that an internally closed cylindrical radio-frequency shield thus results. This soldering cannot be implemented immediately after the placement of the shield segments since these inner solder points are not reachable with a typical manual soldering device in the form of a soldering iron. After the placement of the shield segments, the additional components forming the gradient coil (the individual prefabricated coil elements, cooling devices etc.) are placed on the casting mandrel like shells, after which the structure is fixed and effused with a casting resin (typically epoxy resin). The shield segments as the innermost layer are also cast as well or are fixed via the casting resin. In order to avoid casting resin reaching the solder points of the innermost copper layer, which casting resin must first be removed after the removal of the casting part before the inevitable first possible soldering after this, these solder regions are covered with adhesive tape upon placement of the shield segments on the casting mandrel. Only after the forcible separation from the casting mandrel is this adhesive tape removed, after which the solder points are manually soldered with a soldering iron using a suitable solder band.

This type of production of the radio-frequency shield that is connected with the masking of the solder surfaces as protection before a wetting with casting resin, the removal of the adhesive tapes and the subsequent, complicated manual soldering is involved and time-consuming. The masking with the adhesive tape requires some time; furthermore, this masking does not always lead to a complete protection from a penetration of the casting compound. Finally, the removal of the adhesive tape as well as the subsequent preparation of the solder surfaces (which possibly can still contaminated with residual adhesive from the adhesive tape or by the casting resin itself) as well as the manual soldering are complicated.

### SUMMARY OF THE INVENTION

An object of the present invention is to provide a method to produce a cylindrical radio-frequency shield in the framework of the manufacture of a gradient coil to be cast, which production can be implemented more simply and faster.

This object is achieved in a method of the aforementioned type wherein, according to the invention the shield segments are inductively soldered with one another after the placement on a cylindrical support (in particular a casting mandrel) by means of an inductive soldering device movable along the support.

In accordance with the invention the shield segments are inductively soldered with one another immediately after the placement and alignment of the shield segments on the casting mandrel. Using an induction soldering device (frequently also called an inductor), a magnetic field is generated via the alternating current in the inductor that in turn generates a current flow in adjacent metal to be soldered. This alternating current that is induced without contact in the metal in turn causes cyclic magnetization and eddy current losses in the work piece that lead to a local temperature increase in the induction region. The heating occurs until the employed solder (regardless of type) melts and wets and connects the segments to be connected. It is thus a high-frequency energy induction method to achieve the required component or solder heating. The frequencies used lie in the range of multiple kHz up to the MHz range.

In the method according to the invention, after the segments to be soldered as well as the solder band have been treated if necessary with a flux agent to remove possible oxide layers, a solder band is already placed upon placement of the shield segments under the joint area of two segment edges whose lowermost metal layer is to be soldered. The soldering of the inner metal layer is then conducted using the inductive soldering device that can move along the support, preferably automatically controlled via a corresponding control device. The operating parameters of the inductive soldering device (thus of the inductor) can be set via the device's own control device (which controls a high-frequency generator as part of the inductive soldering device) so that the high-frequency alternating magnetic field that is generated via the inductor penetrates into the placed shield assembly and generates cyclic magnetization and eddy current losses (consequently heating) only in the region of the lower metal layer or, respectively, the solder band. It is thus possible to specifically heat the inner side and to solder this even though the soldering device travels on the outside. In practice, this means that the complicated masking as well as subsequent cleaning connected with this, and in particular the tedious manual soldering after the forcible separation of the finished, cast gradient coil from the casting mandrel, are foregone. Rather, in the method according to the invention the possibility exists to solder the radio-frequency shield on the inner side without contact immediately after placement of the shield segments next to the solder band, in effect through said shield segments. The radio-frequency shield is therefore completely finished before the casting of the gradient coil; the entire soldering process takes place significantly faster and can consequently also be conducted more cost-effectively.

As described, the solder bands are arranged below the segment edges to be soldered with one another because these, like the solder bands themselves (which are, for example, pre-tinned copper bands (thus thin copper foils) or pre-tinned circuit board strips (a thin insulating support that is lined on both sides with copper that is structured on one side like a circuit board with conductive surfaces or, respectively, contact points), have been treated with a flux agent. In principle it would also be possible to conduct the soldering on the outer side (in addition if necessary).

As described, the movement of the inductor that forms the inductive soldering device and is moved directly along the outer side of the shield segments preferably ensues automatically; the travel speed is appropriately freely selectable or, respectively, can be programmed in a control device controlling the operating, which control device controls the HF generator and the operation of a mount or the like moving the inductor. It is possible to equip the movement device with a step motor or the like so that it can be positioned as exactly as possible with regard to the shield segments and also can moved optimally precisely and with fine adjustment capability along the shield segments for a continuous soldering process. The distance of the inductive soldering device from the shield segments to be soldered should also be variable, just as the generation parameters for the high-frequency alternating magnetic field and its penetration depth are also variable. For example, a corresponding distance measurement device is provided at the inductor for distance measurement, which distance measurement device enables a corresponding adjustment.

In addition to the method according to the method, the invention also concerns a cylindrical gradient coil containing a radio-frequency shield, produced according to the method of the described type.

### BRIEF DESCRIPTION OF THE DRAWINGS

FIG. 1 shows a cross-section through a casting mandrel together with shield segments placed thereon, and an associated inductive soldering device, in accordance with the present invention.

FIG. 2 is a side view of the arrangement shown in FIG. 1.

### DESCRIPTION OF THE PREFERRED EMBODIMENTS

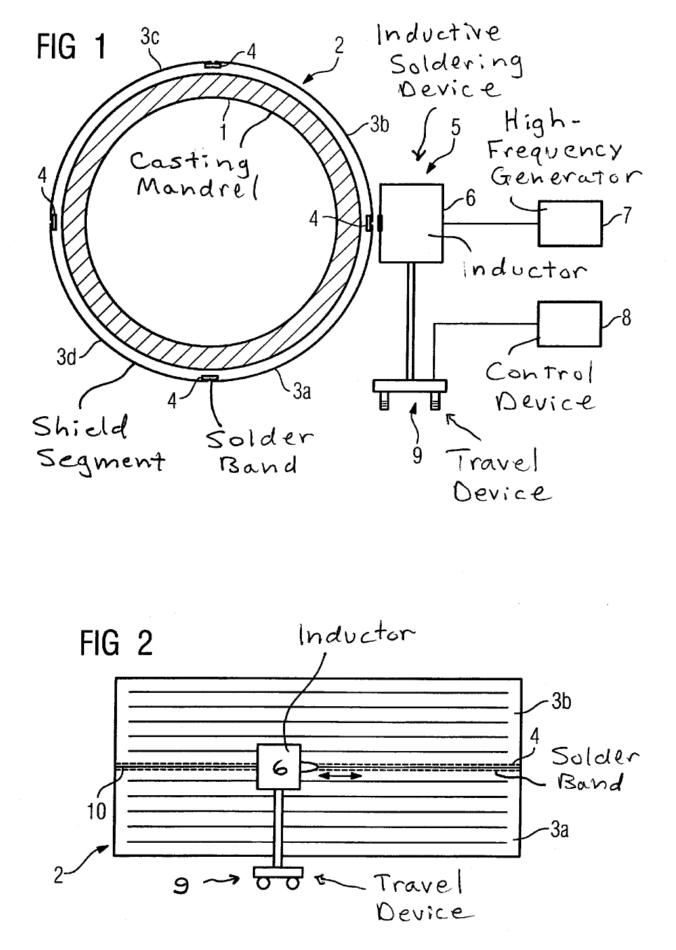

FIG. 1 shows as a basic representation a hollow cylindrical casting mandrel 1 on which four separate shield segments 3a, 3b, 3c and 3d have been placed in the shown exemplary embodiment to form a radio-frequency shield 2, which shield segments 3a, 3b, 3c and 3d all together form a ring. Each shield segment is composed of a flexible insulating support (for example a glass fiber-reinforced plastic support) that is laminated on both sides with a metal layer or metal foil (for example made of copper). These four shield segments 3a-3d are now placed on the casting mandrel 1 and positioned exactly, for which corresponding positioning aids are provided on the casting mandrel in the form of radially spaced bolts etc. (not shown in detail). A solder band 4 (which can be, for example, a thin copper foil coated with soldering tin or a solder paste) is respectively placed below each seam or solder joint of two shield segments. This solder band 4 is placed so that it optimally uniformly and areally overlays the two adjoining edge regions or areal segments at the respective shield segments. The respective solder band thus clearly rests on the lower metal layer of the individual shield segments, which metal layer rests on the casting mandrel 1.

In order to now be able to solder the individual shield segments 3a-3d at this inner point (that is not freely accessible due to the casting mandrel), an inductive soldering device 5 is used in the form of an inductor 6 with associated high-frequency generator 7 and control device 8. This inductor 6 has a corresponding induction loop that serves for the generation of a high-frequency magnetic field that is generated via the generator 7 at the inductor 6. The inductor 6 is now brought close to the region to be connected (see FIG. 1). The inductor 6 is arranged on a travel device 9 that enables an automatic movement operation along the casting mandrel 1 (thus along the solder joint), as is represented by the double arrow in FIG. 2. The automatic movement operation (for example on rails or along a mounting carrying the indicator 6 etc., is likewise controlled via the control device 8.

A targeted heating at depth (here thus directly in the region of the solder band 4) can ensue via the high-frequency alternating magnetic field generated by the inductor 8 that penetrates into the structure. The heating is punctiform and can be generated very exactly at a desired depth so that it is possible without further measures to even actually produce the ultimate heating only in the region of the solder hand via corresponding control via the control device. The soldering tin of the solder band 4 now melts due to this induced heating and consequently connects the adjacent edge segments (here those of the two shield segments 3a, 3b). The inductor 6 is now moved continuously along as described via the movement unit 9 in order to solder the two edges over the entire length, during which movement the soldering tin melts in the region where the inductor is, connects the two edges and subsequently cools again.

After soldering has occurred, a continuous, homogeneous solder surface 10 (that is represented with dashed lines in FIG. 2) has formed over the entire length of the back side of the radio-frequency shield 2.

After the soldering of the two shield segments 3a, 3b, the casting mandrel 1 is rotated by 90° so that the two edge segments (for example of the two shield segments 3b, 3c) can be soldered.

If all solder surfaces 10 have been generated (thus consequently if a closed, cylindrical shield has been generated in the region of the inner metal surface), the additional coil components serving for the production of the cylindrical gradient coil are placed and subsequently case with a suitable casting resin with which the produced radio-frequency shield 2 is also sealed, however without the danger of a wetting in the region of the inner metal layer that, as described, is completely sealed due to the soldering that has already occurred.

Instead of the four shield segments 3a-3d used, it would naturally also be conceivable to use only two or three. A very thin copper band with a thickness of approximately 0.1 mm with corresponding solder paste or soldering tin application is preferably used as a solder band. The width of the band is approximately 10 mm, so that it is ensured that the two shield segment edges abutting one another can be sufficiently covered.

Although modifications and changes may be suggested by those skilled in the art, it is the intention of the inventors to embody within the patent warranted heron all changes and modifications as reasonably and properly come within the scope of their contribution to the art.

We claim as our invention:

1.-5. (canceled)

6. A method to manufacture a cylindrical radio-frequency shield of a cylindrical gradient coil comprising:
placing a plurality of flat shield segments successively next to each other on a cylindrical support in a configuration to form a radio-frequency shield when said flat shield segments are soldered together;
providing a solder band on said mandrel; and
inductively soldering said shield segments to one another by moving an inductive soldering device along a longitudinal axis of said cylindrical support.

7. A method as claimed in claim 6 comprising employing a casting mandrel as said cylindrical support.

8. A method as claimed in claim 6 comprising placing said solder band below edges of the shield segments that are to be soldered to one another.

9. A method as claimed in claim 6 comprising arbitrarily selecting a travel speed of said inductive soldering device along said longitudinal axis.

10. A method as claimed in claim 6 comprising varying a distance of said inductive soldering device from said shield segments.

11. A cylindrical gradient coil comprising a radio-frequency shield manufactured according to the method of claim 6.
